(19) United States
(12) Patent Application Publication
(10) Pub. No.: US 2012/0328927 A1
(43) Pub. Date: Dec. 27, 2012

(54) ELECTROCHEMICAL DEVICES AND RECHARGEABLE LITHIUM ION BATTERIES

(75) Inventors: Adam T. Timmons, Southfield, MI (US); Benjamin R. Christian, Novi, MI (US)

(73) Assignee: GM GLOBAL TECHNOLOGY OPERATIONS LLC, DETROIT, MI (US)

(21) Appl. No.: 13/168,418

(22) Filed: Jun. 24, 2011

(51) Int. Cl. H01M 8/20; H01M 10/04

(52) U.S. Cl. 429/105; 29/623.1

(57) ABSTRACT

An electrochemical device includes an electrochemical cell having a first volume for receiving a liquid reactant negative electrode material, a second volume for receiving a liquid reactant positive electrode material, and a lithium ion exchange membrane positioned between the first and second volumes. Liquid reactant negative electrode material includes lithium or a material including lithium. The lithium ion exchange membrane facilitates a lithium ion exchange reaction between the liquid reactant materials to generate a lithium depleted negative electrode material and a lithium enriched positive electrode material. The device also includes respective fluid exchange mechanisms i) to introduce the liquid reactant positive electrode material into the second volume and to extract the lithium enriched positive electrode material from the second volume and ii) to introduce the liquid reactant negative electrode material into the first volume and to extract the lithium depleted negative electrode material from the first volume.

### TECHNICAL FIELD

The present disclosure relates generally to electrochemical devices and rechargeable lithium ion batteries.

### BACKGROUND

A lithium ion battery is a rechargeable electrochemical cell. Lithium ions move from a cathode (positive electrode) to an anode (negative electrode) during charging of the battery, and from the anode to the cathode when discharging the battery. The lithium ion battery also includes an electrolyte that carries the lithium ions between the cathode and the anode when the battery provides an electric current to an external circuit.

### SUMMARY

Electrochemical devices are disclosed herein. An example of the electrochemical device includes an electrochemical cell having a first volume for receiving a liquid reactant negative electrode material, a second volume for receiving a liquid reactant positive electrode material, and a lithium ion exchange membrane positioned between the first and second volumes. The liquid reactant negative electrode material includes lithium or a material including lithium. The lithium ion exchange membrane facilitates a lithium ion exchange reaction between the liquid reactant negative electrode material and the liquid reactant positive electrode material to generate a lithium depleted negative electrode material and a lithium enriched positive electrode material. The device also includes respective fluid exchange mechanisms i) to introduce the liquid reactant positive electrode material into the second volume and to extract the lithium enriched positive electrode material from the second volume and ii) to introduce the liquid reactant negative electrode material into the first volume and to extract the lithium depleted negative electrode material from the first volume.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 schematically depicts an example of a prior art lithium ion battery;

FIG. 2 schematically depicts another example of a prior art lithium ion battery;

FIG. 3 schematically depicts an example of a lithium ion battery of the present disclosure including a liquid reactant positive electrode and a liquid reactant negative electrode;

FIG. 4 schematically depicts another example of the lithium ion battery of FIG. 3;

FIG. 5 is a perspective, exploded view showing an example of an electrochemical cell including a plurality of flow channels defined in positive electrode and negative electrode current collectors;

FIG. 6 is a schematic diagram illustrating an example of a system including multiple electrochemical cells where current flows in series; and

FIG. 7 is a schematic diagram illustrating an example of a system including multiple electrochemical cells where current flows in parallel.

### DETAILED DESCRIPTION

Lithium ion batteries may be incorporated into hybrid electric and battery powered vehicles to generate enough power to operate one or more systems of the vehicle. For instance, the battery may be used in combination with an internal combustion engine to propel the vehicle (such as in hybrid electric vehicles), or may be used alone to propel the vehicle (such as in battery powered vehicles). Lithium ion batteries may also be used in various consumer electronic devices (e.g., laptop computers, cameras, and cellular/smart phones), military electronics (e.g., radios, mine detectors, and thermal weapons), aircrafts, satellites, and/or the like.

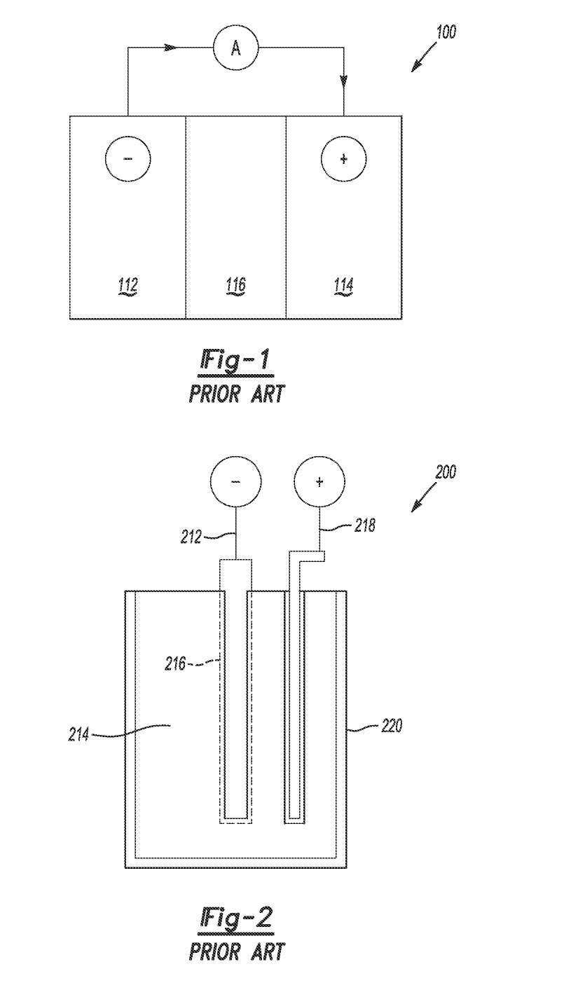

An example of a prior art lithium ion battery construction is schematically depicted in FIG. 1. This battery (identified by reference numeral 100) is a rechargeable electrochemical cell including a solid negative electrode 112 (i.e., an anode), a solid positive electrode 114 (i.e., a cathode), and an electrolyte 116 operatively disposed between the electrodes 112, 114. The anode 112 includes a current collector (not shown) upon which a negative electrode material is applied, and the cathode 114 includes a current collector (also not shown) upon which a positive electrode material is applied. The arrows indicate that current is flowing out of the anode 112 and into the cathode 114, which means that the battery 100 is in a charging state. It is to be understood that this battery 100 also has a discharging state (not shown) where current flows in the opposite direction, i.e., from the cathode 114 to the anode 112.

An alternative construction of the lithium ion battery has been developed and is depicted schematically in FIG. 2. It is believed that this lithium ion battery 200 is capable of being recharged in a more efficient and user-convenient manner than the lithium ion battery 100 shown in FIG. 1. This battery 200 generally includes a battery container 220 having disposed therein a solid anode 212 and a liquid cathode 214. The liquid cathode 214 is separated from the solid anode 212 via a solid or gel electrolyte 216. This battery 200 also includes a current collector 218 in contact with the liquid cathode 214. The anode 212 and current collector 218 are attached to respective terminal electrical leads, which extend out of the container 218 and connect to an external power source (not shown). Further details of this lithium ion battery 200 may be found in U.S. patent application Ser. No. 12/578,813, filed Oct. 14, 2009 (published as U.S. Pat. Pub. No. 2011/0086249 on Apr. 14, 2011).

The examples of the electrochemical device disclosed herein provide benefits beyond those that are achieved with the battery 200. For instance, the reaction rate of the examples of the electrochemical device disclosed herein is not mass-transport limited. This is unlike the battery 200, which may, in some instances, be mass-transport limited when operated without thermal convective currents and/or without some mechanical agitation. Furthermore, the inclusion of both a liquid positive electrode and a liquid negative electrode prevents the deformation of the lithium ion conducting membrane (i.e., the electrolyte) that separates the flow fields of the fluidic electrodes. In examples including both liquid anodes and cathodes, it is believed that the fuel-carrying weight of the device is substantially reduced compared to the battery 200, which requires the long-term presence of excess solid anode material. This is due, at least in part, to the fact that the liquid electrodes disclosed herein may be refilled during charging/refilling processes.

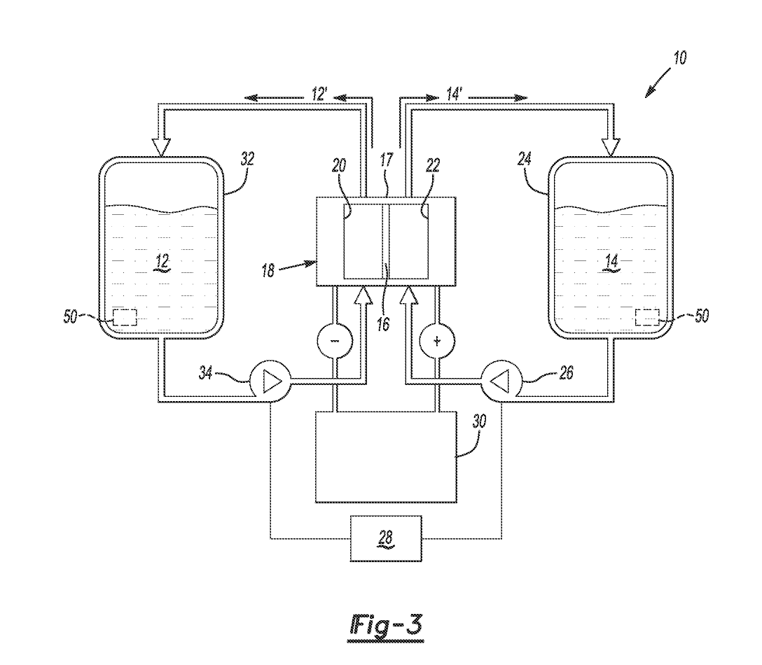

Examples of the electrochemical devices 10, 10′ of the present disclosure are schematically depicted in FIGS. 3 and 4. Each example of the electrochemical device 10, 10′ includes an electrochemical cell 18. The electrochemical cell 18 generally includes a housing 17 that i) defines a first volume 20 and a second volume 22, and ii) contains a lithium ion exchange membrane 16 that separates the volumes 20, 22. The first volume 20 is configured to receive a liquid/molten reactant negative electrode material 12, and the second volume 22 is configured to receive a liquid/molten reactant positive electrode material 14. When a suitable voltage is applied and the reactant electrode materials 12, 14 are both present in the cell 18, but are separated by an electrically isolating yet ionically conductive membrane 16, the electrochemical cell 18 facilitates a reaction between the reactant materials 12, 14. The reaction involves the transfer of lithium ions, and the products of the reaction include lithium depleted negative electrode material 12′ and lithium enriched positive electrode material 14′. The products 12′, 14′ are formed when the cell 18 provides current to an external circuit by facilitating the transfer of lithium from the reactant negative electrode material 12 to the reactant positive electrode material 14. The transfer of lithium changes the state of the materials from the reactant state 12, 14 to the product state 12′, 14′, respectively.

In the examples disclosed herein, the electrode material (whether positive or negative) is substantially in a liquid state at or about room temperature (e.g., about 21° C.). In some examples, the liquid electrode material is substantially in a liquid state at temperatures within about 10 degrees of room temperature. In other examples, the liquid electrode material is substantially in a liquid state at temperatures within about 20 degrees of room temperature. In still other examples, the liquid electrode material is substantially in a liquid state at temperatures within about 50 degrees of room temperature. It is to be understood that the liquid electrode material(s) may be obtained (e.g., purchased) in the solid state, and then heated above their melting temperature to convert the solid electrode material(s) into liquid electrode material(s). As such, any of the electrode materials may be molten materials.

The reactant negative electrode material 12 includes lithium (i.e., pure lithium or lithium including up to about 5 wt % of impurities) or a material including lithium. The material including lithium is a material that includes i) lithium and ii) one or more other materials that may be beneficial to the reaction between the positive and negative reactant electrode materials 12, 14. An example of a material that includes lithium and is suitable for inclusion as the reactant negative electrode material 12 is Li₂ₓGa, where x is the normalized lithium content ranging from zero to one. As will be described further herein in reference to the various figures, the reactant negative electrode material 12 may be in a solid form or in a liquid form. In some instances, molten lithium or a molten material containing lithium may be used, which has been melted to obtain the liquid form of the reactant negative electrode material 12. The melting temperature of molten lithium and the molten material containing lithium may range from about 10° C. to about 200° C.

The reactant positive electrode material 14 may, for example, be selected from any positive electrode material that can reversibly accommodate lithium or lithium ions. In one example, the reactant positive electrode material 14 is a non-reacted material that is reduced after chemically reacting with the lithium that is otherwise stored in the reactant negative electrode material 12. One example of a positive electrode material includes a mixture of molten GaₓSn_{y} with a liquid electrolyte (e.g., 1M LiPF₆ salt) in a substantially equal volumetric mixture of ethylene carbonate and diethyl carbonate. In GaₓSn_{y}, y is equal to the difference between unit y and x (i.e., 1-x) and x ranges from 0.2 to 0.8.

The lithium ion exchange membrane 16 (i.e., electrolyte) is an electrically insulating, and ionically conductive membrane. Electrons flow through a path defined between the current collectors (not shown but described hereinbelow) and an electrical load 30. In an example, the lithium ion exchange membrane may be chosen from polymers (e.g., polyethylene oxide (PEO)) including lithium ions, lithium phosphorus oxynitride (LiPON), lithium glass (e.g., lithium sulfate oxynitride (LiSON), lithium superionic conductors (LiSICON), Li₂S-P₂S₅, etc.), glass-polymer composites (e.g., PEO-LiTFSI, Li₂S-B₂S₃-LiN (CF₅SO₂)₂, and glass ceramic composites.

In the examples disclosed herein, the housing 17 of the electrochemical cell 18 may be formed of a formable (moldable) plastic material, or a laminate material including metal foil, e.g., outer layers of plastic with an inner layer of aluminum foil. The latter housing 17 may be either rigid or flexible and may be impervious to the external atmosphere, including water vapor. The particular housing 17 used in the respective examples will be described further hereinbelow in reference to the various figures.

The previously described materials may be used in any of the example devices 10, 10′ disclosed herein. Each of the devices 10, 10′ will now be described in reference to their respective figures.

The example device 10 shown in FIG. 3 includes the electrochemical cell 18, which includes a housing 17 that receives a liquid reactant negative electrode material 12 in the volume 20 and receives a liquid reactant positive liquid electrode 14 in the volume 22. Each of the liquid reactant electrode materials 12, 14 is housed in a separate storage tank 32, 24. This example of the housing 17 includes at least two sealed accessible openings (not shown), such as quick connect fittings, for each of the volumes 20, 22. The openings fluidly connected to volume 20 respectively allow the liquid reactant negative electrode material 12 to be delivered to the volume 20 and allow the reacted liquid negative electrode material (i.e., lithium depleted negative electrode material) 12′ and any unused reactant negative electrode material 12 to exit from the volume 20. If lithium is selected as the reactant negative electrode material 12, the cell 18 may be designed so that the entire volume of molten lithium transports as lithium ions through the exchange membrane 16 to react with the liquid reactant positive electrode material 14 during operation of the cell 18. In this example, no material 12′ would be formed because all of the material 12 (i.e., lithium in this example) would be reacted. The openings fluidly connected to volume 22 respectively allow the liquid reactant positive electrode material 14 to be delivered to the volume 22 and allow the reacted liquid positive electrode material (i.e., lithium enriched positive electrode material) 14′ and any unused reactant positive electrode material 14 to exit from the volume 22.

This example of the housing 17 may also include a removable access cover disposed adjacent the membrane 16 to allow access to and replacement of the membrane 16.

As mentioned above, the reactant positive electrode material 14 is contained in a storage tank 24 and the reactant negative electrode material 12 is contained in the storage tank 32. The storage tanks 24 and 32 may be made from an expandable material such as a rubber. Some specific examples of materials from which the storage tanks 24, 32 may be formed include polybutadiene, polyacrylate, and/or polyester urethane rubber. Use of the expandable material will enable the storage tank 24 to expand to accommodate a larger volume of lithium enriched electrode material 14′, while use of the expandable material will enable the storage tank 32 to contract to accommodate a smaller volume of lithium depleted electrode material 12′. A single tank, with or without separate cavities, could be used to contain the reactant and product positive electrode materials 14, 14′.

The materials 12, 14 may be stored in the tanks 24, 32 in liquid form or in solid form. When maintained in liquid form in the tank(s) 32, 24, a desirable amount of the respective materials 12, 14 is pumped into the cell 18 as the liquid. When maintained in solid form in the tank(s) 32, 24 a desirable amount of the respective materials 12, 14 needed for proper operation of the cell 18 is melted so as to be pumped as a liquid into the cell 18. In one example, the product(s) 12′, 14′ pumped back into the respective tanks 32, 24 may freeze.

In one example, the storage tank 24 may be equipped with a heating device (e.g., a heating coil or the like, which is schematically shown as reference numeral 50 in FIG. 3) which supplies enough heat to maintain the reactant positive electrode material 14 in the liquid state or to liquefy enough of the reactant positive electrode material 14 for transition into the volume 22 (or flow field of the electrode 14 in the cell 18). Similarly, the storage tank 32 may be equipped with a heating device (e.g., a heating coil or the like, which is also schematically shown as reference numeral 50 in FIG. 3) which supplies enough heat to maintain the reactant negative electrode material 12 in the liquid state or to liquefy enough of the reactant negative electrode material 12 for transition into the volume 20 (or flow field of the electrode 12 in the cell 18). The respective heating device may be activated (e.g., by control electronics) when it is sensed that the ambient temperature is below the freezing point of the electrode material 14 or the electrode material 12, and/or the heating power may be modulated according to the demand of the volumetric flow rate of the liquid electrode material 14 or the liquid electrode material 12 through the electrochemical cell 18 such that the device 10 can deliver the desired power output that is the product of device potential and current delivered to the external circuit. It is to be understood that the freezing point may change depending, at least in part, on the degree of oxidation of the materials 12, 14 in the respective tanks 32, 24. In another example, the electrode materials 14, 12 are maintained in the liquid state utilizing heat generated from the reaction that occurs when the negative electrode material 12 and the positive electrode material 14 are present in the cell 18. Alternatively, the electrodes 12, 14 may persist in their respective tanks 32, 24 with one 12 or the other 14 or both 12, 14 in solid form except for a small fraction (as compared to the total possible volume in liquid form) such that just enough of the electrode material 12 and/or 14 is melted to facilitate proper operation of the cell 18. In any of these examples, a desirable amount of the reactant positive electrode material 14 and the reactant negative electrode material 12 is maintained in liquid form while power is being generated by the electrochemical device 10. In yet another example, the electrode material 14 may be contained in a carrier material (e.g., mercury) that maintains the electrode material 14 in the liquid state. In this example, the electrode material 14 would not have to be heated by a separate heating device or by the heat generated by the reaction.

As illustrated in FIG. 3, the electrochemical device 10 further includes a fluid exchange mechanism 26 that, in combination with multiple fluid conduits, selectively allows liquid positive reactant fluid (e.g., 14) to flow from the storage tank 24 to and through the volume 22, and reacted or spent fluid (e.g., lithium enriched positive electrode material 14′) to flow back into the storage tank 24. In addition to extracting the lithium enriched positive electrode material 14′, the fluid mechanism 26 also extracts unused reactant electrode 14 from the volume 22. One example of the fluid exchange mechanism 26 is a pump. Fluid flow of the liquid reactant positive electrode material 14 from the storage tank 24 to and through the volume 22, and fluid flow of the product 14′ and unused reactant 14 back to the storage tank 24 may otherwise be accomplished utilizing gravity. In this case, the flow of the fluids (e.g., 14, 14′) would be controlled utilizing an electronically controlled valve.

The electrochemical device 10 includes another fluid exchange mechanism 34 that, in combination with multiple fluid conduits, selectively allows liquid negative reactant fluid (e.g., 12) to flow from the storage tank 32 to and through the volume 20. The fluid exchange mechanism will also allow reacted or spent fluid (e.g., lithium depleted negative electrode material 12′) to flow back into the storage tank 32. In addition to extracting the lithium depleted negative electrode material 12′, the fluid mechanism 34 also extracts unused reactant electrode 12 from the volume 22. It is to be understood that reacted or spent fluid 12′ may not be present in instances where pure lithium is utilized as the material 12 and all of the material 12 is reacted. One example of the fluid exchange mechanism 34 is a pump. Fluid flow of the liquid reactant negative electrode material 12 from the storage tank 34 to and through the volume 20, and fluid flow of any product 12′ and unused reactant 12 back to the storage tank 34 may otherwise be accomplished utilizing gravity. In this case, the flow of the fluids (e.g., 12, 12′) would be controlled utilizing an electronically controlled valve.

The fluid exchange mechanisms 26, 34 are electrically connected to a single control system 28 which includes electronics suitable for operating the fluid exchange mechanisms 26, 34. In one example, the control electronics 28 and pumps 26, 34 control the flow rate of the liquid positive electrode material 14 and the liquid negative electrode material 12 through the device 10, which in turn controls the rate of reduction (i.e., lithium ion transfer) based, at least in part, on power demand. For example, when it is desirable for the device 10 to generate more power, the control electronics 28 will transmit a command to the fluid exchange mechanisms 26, 34 to increase the flow of the liquid reactant positive electrode material 14 and the liquid reactant negative electrode material 12 into and through the cell 18.

In this example, it is to be understood that the liquid reactant positive electrode material 14 (which is pumped into the volume 22) reacts with lithium when the lithium stored in the liquid reactant negative electrode material 12 moves through the lithium ion exchange membrane 16 from the reactant negative electrode material 12 to the reactant positive electrode material 14. The voltage and current furnished by the electrochemical cell 18 is a function of the number of lithium ions that can transfer across the membrane 16 per unit time, and the potential difference experienced by those ions between the initial negative electrode material 12 and final positive electrode material 14′, respectively.

It is to be understood that the positive electrode material 14 is reduced to form lithium enriched positive electrode material 14′ during the reaction that occurs at the electrochemical cell 18, and the reacted material/product 14′ produced may be referred to herein as the reduced material. It is further to be understood that the negative electrode material 12 is oxidized to form lithium depleted negative electrode material 14′ during the reaction that occurs at the electrochemical cell 18, and the reacted material/product 12′ produced may be referred to as the oxidized material.

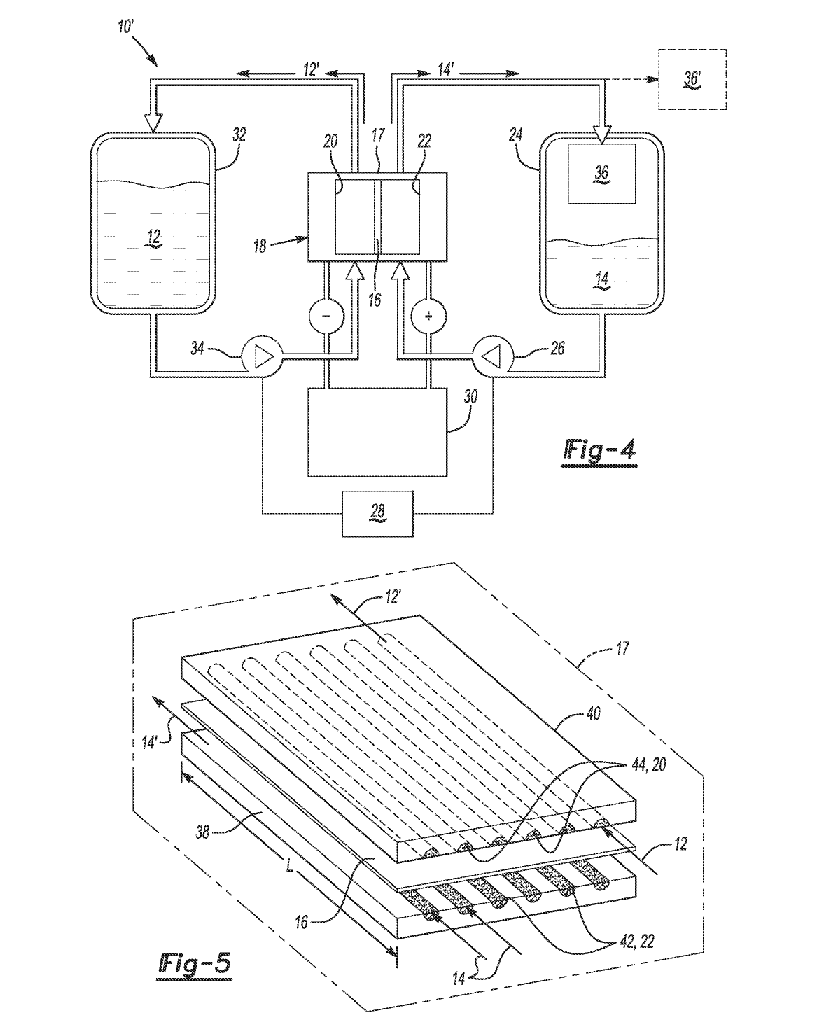

While not shown in FIG. 3, the cell 18 also includes current collectors (previously mentioned) that are positioned within the volumes 20, 22 or define the volumes 20, 22 (see, e.g., FIG. 5). The current collectors operate to conduct electrical current with respect to the electrode materials 12, 14 during the reaction (i.e., battery discharge). The current collectors are made of materials that are highly electrically conductive and that do not react with lithium at the potentials pertinent to their use. In the device 10 shown in FIG. 3, the current collectors may both be solids plates. The respective current collectors are positioned in the cell 18 so that the liquid reactant positive electrode material 14 comes in contact with one of the plates when introduced into the volume 22 and the liquid reactant negative electrode material 12 comes in contact with the other of the plates when introduced into the volume 20.

The reacted material 14′ in this example is transferred to the storage tank 24 via fluid conduits and operation of the fluid exchange mechanism 26. Similarly, any reacted material 12′ in this example is transferred to the storage tank 32 via fluid conduits and operation of the fluid exchange mechanism 34. In this example then, the spent/reacted material 14′ may mix with the reactant (i.e., active) form of the material 14, which dilutes the reactant form of the material 14; and the reacted material 12′ may mix with the reactant (i.e., active) form of the material 12, which dilutes the reactant form of the material 12. As the chemical reaction occurs, the concentration of both the reactant material 14 and the reactant material 12 will deplete. This may require an increase in the flow rate in order to maintain a desirable level of power generation. In some examples, the common tanks 32, 24 will employ an impermeable separation between a variable volume cavity that contains the reactant materials 12, 14 and a variable volume cavity that contains the product materials 12′, 14′.

Referring now to FIG. 4, the example of the device 10 shown in FIG. 3 is depicted with the addition of a waste tank 36 or 36′. This example of the device is identified as reference numeral 10′. It is to be understood that the device 10′ will include either the waste tank 36 or the waste tank 36′. These waste tanks 36, 36′ may be desirable, at least in part because the spent/reacted material 14′ is not mixed with the reactant (active) positive electrode material 14 present in the storage tank 24. The separate waste tanks 36, 36′ help to ensure that a consistent concentration of the reactant (active) positive electrode material 14 is delivered to the volume 22.

In an example of the device 10′ including waste tank 36, the tank 36 is a non-conductive elastic accumulator located inside of the storage tank 24, and the waste tank 36 may be formed from any of the expandable materials identified above for the storage tank 24. It is to be understood that the waste tank 36 is a sub-tank of the storage tank 24, but the contents of the waste tank 36 are not in fluid communication with the contents of the storage tank 24. When this tank 36 is used, the device 10′ includes a conduit that directly connects the volume 22 to the waste tank 36. This tank 36 operates similarly to a hydraulic accumulator tank. As the material 14 is withdrawn from the storage tank 24, the reacted material 14′ fills the waste tank 36. As such, the waste tank 36 fills as the storage tank 24 is depleted. During refilling, the introduction of the material 14 into the storage tank 24 pushes the spent/reacted material 14′ out of the waste tank 36. This example may be particularly desirable because the required volume of the storage and waste tanks 24, 36 is reduced while still providing the consistent concentration of liquid positive electrode material 14 to the cell 18.

In an example of the device 10′ including waste tank 36′, the tank 36′ is a stand-alone tank that is located outside of the storage tank 24. When this tank 36′ is used, the device 10′ includes a conduit that directly connects the volume 22 to the waste tank 36′. The stand-alone waste tank 36′ may be made of any suitable material, including those mentioned above for the storage tank 24.

The configuration of the examples of the electrochemical device 10, 10′ of FIGS. 3 and 4 resembles the basic configuration of a polymer electrolyte membrane (PEM) fuel cell, but the nature of the materials used for the electrochemical device are selected to furnish the lithium reaction. The lithium reaction of the electrochemical devices 10, 10′ is believed to have a reaction potential that is at least twice that of a functioning PEM hydrogen fuel cell.

As previously mentioned, each of the examples disclosed herein includes current collectors within the electrochemical cells 18. FIG. 5 illustrates one example of the current collectors 38, 40 that can be used when both of the electrode materials 12 and 14 are liquid.

The current collector 38 includes channels 42 formed therein. The channels 42 are defined in a surface of the current collector 38 via, for example, any suitable method, such as molding (e.g., injection molding), casting, machining, etc. In this example, the channels 42 together define the volume 22 of the cell 18 that receives liquid reactant positive electrode material 14. The channels 42 are defined in the surface of the current collector 38 that will face the lithium ion exchange membrane 16. The channels 42 may have any suitable cross-section and dimensions. Each channel 42 has an opening that receives the non-reacted liquid positive electrode material 14 (from the storage tank 24 via a conduit) and another opening that allows the reacted liquid positive electrode material 14′ to exit the cell 18. Each of the channels 42 also extends the length L of the current collector 38 so that liquid positive electrode material 14 introduced therein and pushed therethrough can react along the entire length of the channel 42. More current may be generated if the length of the channel 42 is increased, at least in part because more material 14 is available for reaction. Current is proportional to the area of one liquid electrode 14 in contact with the exchange membrane 16 in contact with the area of the other liquid electrode 12. Assuming all other things being equal, adding length to the channels 42 increases those contact areas, which in turn increases the amount of current. Increasing the width of the channels 42 may also increase the amount of current generated. It is to be understood that in some instances, the channel width and depth may vary along length depending, at least in part, on when in the flow path the channel 42 exists. The current collector 40 includes channels 44 formed therein. The channels 44 are defined in a surface of the current collector 40 via any suitable method, such as molding, casting, machining, etc. In this example, the channels 44 define the volume 20 of the cell 18 that utilizes a liquid reactant negative electrode material 12. The channels 44 are defined in the surface of the current collector 40 that will face the lithium ion exchange membrane 16. The channels 44 may have any suitable cross-section and dimensions, so long as they enable the introduced liquid negative electrode material 12 to contact the liquid positive electrode material 14 introduced into the channels 42. Each channel 44 has an opening that receives the non-reacted liquid negative electrode material 12 (from the storage tank 32 via a conduit) and another opening that allows the reacted liquid negative electrode material 12′ to exit the cell 18, 18′. Each of the channels 44 also extends the length of the current collector 38 so that liquid negative electrode material 12 introduced therein and pushed therethrough can react along the entire length of the channel 44. More current may be generated if the length and/or width of the channel 44 is/are increased, at least in part because more material 14 is available for reaction. It is to be understood that in some instances, the channel width and depth may vary along length depending, at least in part, on when in the flow path the channel 44 exists.

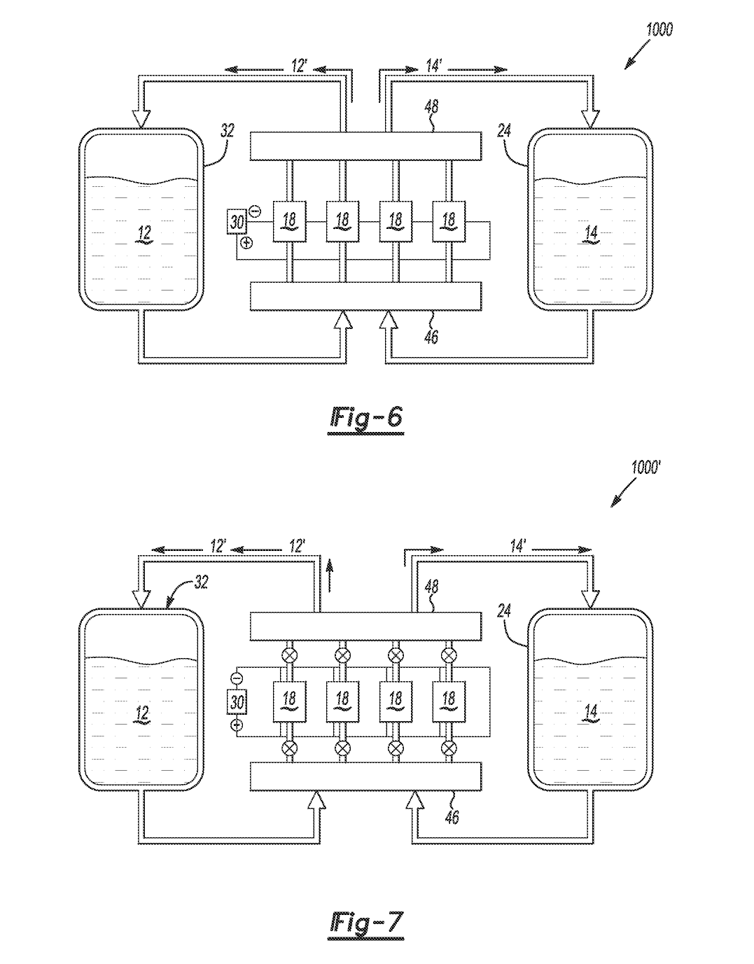

The examples of the electrochemical device 10, 10′ may be configured with a manifold system so that the electrochemical device includes multiple cells 18 connected by opposed manifolds 46, 48. Connection to the opposed manifolds 46, 48 may be by any suitable mechanisms that enables fluid transfer from the manifold 46 to the respective cells 18, and then from the respective cells 18 to the manifold 48. As shown in FIGS. 6 and 7, the device 10, 10′ includes four electrochemical cells 18. However, it is to be understood that the device 10, 10′ may include any number of cells 18. FIG. 6 is a schematic diagram illustrating an example of a system 1000 including multiple electrochemical cells 18 connected to a manifold system, where current flows through the device 10, 10′ in series, and FIG. 7 is a schematic diagram illustrating an example of a system 1000′ including multiple electrochemical cells 18 connected to a manifold system, where current flows through the device 10, 10′ in parallel.

As depicted, each of these systems 1000, 1000′ includes a single storage tank 24 for the reactant positive electrode material 14 and a single storage tank 32 for the reactant negative electrode material 12. These tanks 24, 32 supply the liquid forms of the respective electrode materials 12, 14 to each of the cells 18 via the supply manifold 46, and return any reacted materials 12′, 14′ (and in some instances unreacted materials 12, 14) to their respective storage tanks 32, 24 via the discharge manifold 48. The discharge manifold 48 is used to transfer the materials 12′, 14′ back to the respective tanks 32, 24 (or the waste tank 36 or 36′ is used).

Further, a voltage is applied to the electrochemical cells 18 of the devices 1000, 1000′ utilizing the voltage supply or load 30. As previously mentioned, the cells 18 are electrically connected in series in FIG. 6 and in parallel in FIG. 7. While not shown, it is to be understood that any combination of series and/or parallel connections may be made.

In the examples shown in FIGS. 6 and 7, the cells 18 can be injection molded and joined together by virtue of connection to the respective manifolds 46, 48. Other manufacturing methods may also be used to form the cells 18′ and join the cells 18′ together.

The storage tanks 24, 32 can be quickly emptied and refilled. Examples of methods suitable for emptying and refilling such tanks 24, 32 are described in U.S. patent application Ser. No. 12/578,813 (U.S. Pat. Pub. No. 2011/0086249), and will be briefly described herein.

At the outset, the storage tank(s) 24 and/or 32 is/are provided sealably connected (e.g., substantially air tight to ensure a water-vapor free and oxygen-free environment) to a respective fill (fluid-in) manifold and a respective drain (fluid-out) manifold (e.g., when a separate waste tank 36 is not used).

The power and capacity (state of electric charge) of respective individual lithium ion cells 18 may be measured by conventional means, either individually or as connected in series. It will be appreciated that the power and capacity measurement may be made prior to connecting to respective manifolds.

If the reactant electrode material 12, 14 is solid or partially solid, the electrode material 12, 14 may be heated, for example by resistive heating structures surrounding the storage tanks 32, 24 and/or by introducing a heated liquid, such as a heated solvent into the storage tanks 32, 24 through the fill (fluid-in) manifold. The liquid electrode materials 12, 14 may then be removed from the respective storage tanks 32, 24 substantially simultaneously e.g., by draining the liquid electrode material 12, 14 and/or by pumping a solvent or fresh liquid reactant electrode material 12, 14 through the fill (fluid-in) manifold and into and through the storage tanks 32, 24 to replace reacted liquid electrode materials/products 12′, 14′ into the drain (fluid-out) manifold and subsequently out of the drain manifold. The products 12′, 14′ may be captured in a suitable container for subsequent recycling or resale.

Following removal of the spent liquid electrode materials/products 12′, 14′, one or more fresh liquid electrode materials 12, 14 may be respectively introduced into the storage tanks 32, 24 from one or more liquid electrode material 12, 14 sources through the fluid-in manifold.

It will also be appreciated that removal of the spent liquid electrode materials/products 12′, 14′ may take place in a separate step prior to introduction of fresh liquid reactant electrode materials 12, 14 and/or simultaneously with introduction of fresh liquid reactant electrode materials 12, 14, e.g., where spent liquid electrode materials/products 12′, 14′ are at least partially displaced out of the respective tanks 32, 24 upon introduction of fresh liquid reactant electrode materials 12, 14. It will further be appreciated that introduction or flow of fresh liquid reactant electrode materials 12, 14 may optionally include an intermediate rinsing step or that introduction or flow of fresh liquid reactant electrode materials 12, 14 may take place over a period of time to substantially remove the spent liquid electrode materials/products 12, 14′.

The device 10, 10′ and/or system 1000, 1000′ may be tested in-situ prior to or following disconnection from the liquid electrode material sources to determine a power and capacity, e.g., including comparing to a baseline to determine whether the device 10, 10′ and/or system 1000, 1000′ are sufficiently recharged, e.g., that the power and/or capacity is greater than a predetermined threshold value. If it is determined that the device 10, 10′ and/or system 1000, 1000′ is not sufficiently recharged, the process may began again to introduce additional fresh reactant electrode materials 12, 14. If, however, it is determined that the device 10, 10′ and/or system 1000, 1000′ is sufficiently recharged, the respective manifolds and/or the liquid electrode material/solvent containers may be disconnected and the storage tanks 24, 32 sealably closed.

Connecting and/or disconnecting of respective manifolds and/or storage tanks 24, 32 may take place in a fully or partially inert gas atmosphere e.g., argon, and/or nitrogen, for example, where an inert gas may be blown onto (externally) and/or through respective connection inputs/outputs during connection and/or disconnection. For example, inert gas may be blown through a separate input/output in a respective manifold during disconnection of conduits from manifold inputs. Additionally or alternatively, inert gas may be bubbled through the spent liquid electrode materials/products 12′, 14′ within the storage tanks 32, 24 to provide a positive pressure outflow at respective inputs/outputs as connecting conduits are being disconnected to prevent or minimized introduction of external air and water vapor into the storage tanks 32, 24.

The emptying and refilling technique may be used with storage tanks 24 and 32. When waste tanks 36 or 36′ are utilized, the emptying and refilling technique may still be desirable to remove any remaining material 14 in tank 24.

The examples of the electrochemical device 10, 10′ may be used, for example, in a vehicle such as a hybrid electric vehicle (HEV), a battery electric vehicle (BEV), a plug-in HEV, or an extended-range electric vehicle (EREV). The device 10, 10′ may be used alone, for example, in a battery system disclosed in the vehicle, or may be one of a plurality of batteries of a battery module or pack disclosed in the vehicle. In the later instance, the plurality of batteries may be connected in series or in parallel via electrical leads. In some cases, the electrochemical cell 18 alone may be disposed inside a container e.g., housing 17), or the entire electrochemical device 10, 10′ may be disposed inside a container.

It is to be understood that the size of the electrochemical device 10, 10′ depends, at least in part, on the amount of power to be generated from the device 10, 10′. For instance, an automobile may require more power output from the device 10, 10′ than for a smaller vehicle such as, e.g., a garden tractor. Thus, the size of the device 10, 10′ (in terms of both volume and power generation capabilities) would be significantly larger for use in the automobile than the size required for use in the smaller vehicle.

It is to be understood that the ranges provided herein include the stated range and any value or sub-range within the stated range. For example, a temperature ranging from about 11° C. to about 31° C. should be interpreted to include not only the explicitly recited amount limits of about 11° C. to about 31° C., but also to include individual amounts, such as 14° C., 23° C., 30° C., etc., and sub-ranges, such as 15° C. to 25° C., etc. Furthermore, unless otherwise defined herein, when “about” is utilized to describe a value, this is meant to encompass minor variations (up to +/−5%) from the stated value.

While several examples have been described in detail, it will be apparent to those skilled in the art that the disclosed examples may be modified. Therefore, the foregoing description is to be considered non-limiting.

1. An electrochemical device, comprising:
an electrochemical cell, including:
a first volume for receiving a liquid reactant negative electrode material, the liquid reactant negative electrode material including lithium or a material including lithium;
a second volume for receiving a liquid reactant positive electrode material; and
a lithium ion exchange membrane positioned between the first and second volumes, the lithium ion exchange membrane facilitating a lithium ion exchange reaction between the liquid reactant negative electrode material and the liquid reactant positive electrode material to generate a lithium depleted negative electrode material and a lithium enriched positive electrode material; and
respective fluid exchange mechanisms i) to introduce the liquid reactant positive electrode material into the second volume and to extract the lithium enriched positive electrode material from the second volume, and ii) to introduce the liquid reactant negative electrode material into the first volume and to extract the lithium depleted negative electrode material from the first volume.

2. The electrochemical device as defined in claim 1, further comprising a storage tank for holding the liquid reactant positive electrode material or a solid form of the reactant positive electrode material, wherein one of the respective fluid exchange mechanisms includes a pump for i) withdrawing the liquid reactant positive electrode material from the storage tank as directed by a control system, and ii) transferring the liquid reactant positive electrode material to the second volume.

3. The electrochemical device as defined in claim 2 wherein upon transferring the liquid reactant positive electrode material to the second volume via the pump, the liquid reactant positive electrode material is reacted with lithium stored in the liquid reactant negative electrode material to form the lithium depleted negative electrode material and the lithium enriched positive electrode material, and wherein the pump is further configured to transfer the lithium enriched positive electrode material to the storage tank.

4. The electrochemical device as defined in claim 2, further comprising a second storage tank for holding the liquid reactant negative electrode material or a solid form of the reactant negative electrode material, wherein an other of the respective fluid exchange mechanisms includes a pump for i) withdrawing the liquid reactant negative electrode material from the storage tank as directed by the control system, and ii) transferring the liquid reactant negative electrode material to the first volume.

5. The electrochemical device as defined in claim 4 wherein the other of the respective fluid exchange mechanisms includes a pump for i) withdrawing the liquid reactant negative electrode material from the second storage tank as directed by the control system, and ii) transferring the liquid reactant negative electrode material to the first volume.

6. The electrochemical device as defined in claim 4 wherein the electrochemical cell further includes:
a negative electrode current collector having a plurality of flow channels defined therein, wherein the plurality of flow channels defines the first volume and allows the liquid reactant negative electrode material to flow through the negative electrode current collector; and
a positive electrode current collector having a plurality of other flow channels defined therein, wherein the plurality of other flow channels defines the second volume and allows the liquid reactant positive electrode material to flow through the positive electrode current collector;
wherein the lithium ion exchange membrane is disposed between the negative electrode current collector and the positive electrode current collector.

7. The electrochemical device as defined in claim 1 wherein the liquid reactant negative electrode material has a melting temperature ranging from about 10° C. to about 200° C.

8. The electrochemical device as defined in claim 1 wherein the lithium ion exchange membrane is formed from any of polymers including lithium ions, lithium phosphorus oxynitride, lithium sulfide glass, glass-polymer composites, or glass ceramic composites.

9. The electrochemical device as defined in claim 1 wherein the electrochemical device includes a plurality of electrochemical cells, and wherein the electrochemical device is configured so that current flows in series, in parallel, or combinations thereof.

10. The electrochemical device as defined in claim 1 wherein the electrochemical device is a rechargeable lithium ion battery.

11. A rechargeable lithium ion battery, comprising:
an electrochemical cell, including:
a positive electrode current collector including channels for receiving a liquid reactant positive electrode material;
a negative electrode current collector including channels for receiving a liquid reactant negative electrode material including lithium or a material including lithium; and
a lithium ion exchange membrane positioned between the positive electrode current collector and the negative electrode current collector;
a first storage tank for holding the liquid reactant positive electrode material or a solid form of the reactant positive electrode material;
a pumping mechanism operatively connected to the first storage tank for i) withdrawing the liquid reactant positive electrode material from the first storage tank as directed by a control system, and ii) transferring the liquid reactant positive electrode material to the channels of the positive electrode current collector;
a second storage tank for holding the liquid reactant negative electrode material or a solid form of the reactant positive electrode material;
an other pumping mechanism operatively connected to the second storage tank for i) withdrawing the liquid reactant negative electrode material from the second storage tank as directed by a control system, and ii) transferring the liquid reactant negative electrode material to the channels of the negative electrode current collector; and
a power source operatively connected to the positive electrode current collector and the negative electrode current collector for establishing a current path between the current collectors;
wherein a lithium ion exchange reaction occurs between the liquid reactant negative electrode material and the liquid reactant positive electrode material as the materials flow through the respective channels to generate a lithium depleted negative electrode material and a lithium enriched positive electrode material.

12. The rechargeable lithium ion battery as defined in claim 11, further comprising a waste tank for receiving the lithium enriched positive electrode material from the positive electrode current collector via the pumping mechanism.

13. The rechargeable lithium ion battery as defined in claim 11 wherein the liquid reactant negative electrode material has a melting temperature ranging from about 10° C. to about 200° C.

14. The rechargeable lithium ion battery as defined in claim 11 wherein the liquid reactant positive electrode material includes a mixture of molten GaₓSn_{y} with LiPF₆ salt in a mixture of ethylene carbonate and diethyl carbonate, where y equals a difference between unity and x, and x ranges from 0.2 to 0.8.

15. The rechargeable lithium ion battery as defined in claim 11 wherein the lithium ion exchange membrane is chosen from a glass including lithium ions or a polymer including lithium ions.

16. The rechargeable lithium ion battery as defined in claim 11, further comprising respective heating mechanisms operatively connected to the first and second storage tanks to respectively heat an amount of the solid form of the reactant negative electrode material and an amount of the solid form of the reactant positive electrode material.

17. A method of making a rechargeable lithium ion battery, comprising:
forming an electrode assembly by arranging a lithium ion exchange membrane between a positive electrode current collector and a negative electrode current collector;
fluidically connecting i) a first storage tank to the positive electrode current collector, and ii) a second storage tank to the negative electrode current collector, the first storage tank to hold a liquid reactant positive electrode material or a solid form of the reactant positive electrode material and the second storage tank to hold a liquid reactant negative electrode material or a solid form of the reactant negative electrode material, the reactant negative electrode material including lithium or a material including lithium; and
associating a respective pumping mechanism with each of the first and second storage tanks such that i) a first pumping mechanism withdraws the liquid reactant positive electrode material from the first storage tank, and transfers the liquid reactant positive electrode material to the positive electrode current collector where the liquid reactant positive electrode material becomes a lithium enriched positive electrode material, and ii) a second pumping mechanism retrieves the liquid reactant negative electrode material from the second storage tank, and transfers the liquid reactant negative electrode material to the negative electrode current collector where the liquid reactant negative electrode material becomes a lithium depleted negative electrode material.

18. The method as defined in claim 17, further comprising:
fluidically connecting a waste tank to the first storage tank; and
associating the first pumping mechanism with the waste tank, the first pumping mechanism further configured to transfer the lithium enriched positive electrode material from the positive electrode current collector to the waste tank.

19. The method as defined in claim 17 wherein the positive electrode current collector and the negative electrode current collector individually include a plurality of flow channels defined therein.

20. The method as defined in claim 17 wherein the lithium ion battery is one of a plurality of lithium ion batteries of an electrochemical device, and wherein the electrochemical device is configured so that current flows in series, in parallel, or combinations thereof.
